(19) United States
(12) Patent Application Publication
(10) Pub. No.: US 2014/0131177 A1
(43) Pub. Date: May 15, 2014

(54) Dampened Radius Modular Conveyor Belts and Belt Modules

(71) Applicant: Habasit AG, (US)

(72) Inventors: Jeffrey Delair, Reading, PA (US); Bob Gladzak, Reading, PA (US)

(73) Assignee: Habasit AG, Reinach (CH)

(21) Appl. No.: 13/678,403

(22) Filed: Nov. 15, 2012

(51) Int. Cl. B65G 15/30

(52) U.S. Cl. CPC B65G 15/30
USPC 198/853

(57) ABSTRACT

Provided is a conveyor belt is having of a plurality of modules, each module having an intermediate section, a plurality of first link ends having transverse openings, and a plurality of second link having elongate transverse openings. The first link ends and the second link ends of a module are configured to extend in opposite directions and interdigitate with the corresponding link ends of an adjacent module. Each first link end includes a transverse opening, and each second link end includes an elongate opening configured to be in registry with the openings of the first link ends when two modules are interdigitated. A pivot rod is disposed through the openings and elongate openings of adjacent modules such that the modules are connected. Each module has at least one dampener configured to reduce a magnitude of vibration transmitted between the module and its adjacent module.

### FIELD OF THE INVENTION

The present invention relates to modular conveyor belts, and more particularly to radius conveyor belts.

### BACKGROUND OF THE INVENTION

Previous conveyor belts collapsed to a radius defined by the shape of the link ends, where a small inside radius may cause the inner-most link ends of each module would contact the intermediate section between the inner-most link ends of an adjacent module. In practice, the radius belts are generally capable of collapsing beyond the radius of a curve of the conveyor system on which the belt was used. The difference between this minimum radius of the belt and the smallest radius of the conveyor system caused belt chatter—vibration and noise caused by the irregular collapse of the conveyor belt modules.

Accordingly, there is a need for a radius conveyor belt which minimizes vibration and noise caused by the travel of the belt around curves in the belt path.

### BRIEF SUMMARY OF THE INVENTION

The present invention may be embodied as a conveyor belt, such as an endless modular conveyor belt able to travel around curved belt paths. The conveyor belt is comprised of a plurality of modules, each module having an intermediate section, a plurality of first link ends extending outwardly from the intermediate section in a direction of belt travel, and a plurality of second link ends extending outwardly from the intermediate section in a direction opposite the first link ends. In this way, the first link ends of a module are configured to interdigitate with the second link ends of an adjacent module.

Each first link end includes a transverse opening, and each second link end includes an elongate opening configured to be in registry with the openings of the first link ends when two modules are interdigitated. A pivot rod is disposed through the openings and elongate openings of adjacent modules such that the modules are connected. Each module further comprises a dampener configured to reduce a magnitude of vibration transmitted between the module and its adjacent module.

The present invention may be embodied as a module, as described above, for use in a dampened conveyor belt.

### DESCRIPTION OF THE DRAWINGS

For a fuller understanding of the nature and objects of the invention, reference should be made to the following detailed description taken in conjunction with the accompanying drawings, in which:

FIG. 1 depicts a portion of a conveyor belt according to an embodiment of the present invention and showing conveyor rails;

FIG. 2A is a perspective view of a conveyor belt module according to another embodiment of the present invention;

FIG. 2B is an elevation view of the module of FIG. 2A;

FIG. 2C is a top view of the module of FIG. 2A;

FIG. 2D is an elevation view of the module of FIGS. 2A and 2B showing the opposite elevation from FIG. 2B;

FIG. 2E is an end view of the module of FIG. 2A;

FIG. 2F is an end view of a module according to another embodiment of the present invention; and

FIG. 3 depicts a prior art spiral conveyor system.

### DETAILED DESCRIPTION OF THE INVENTION

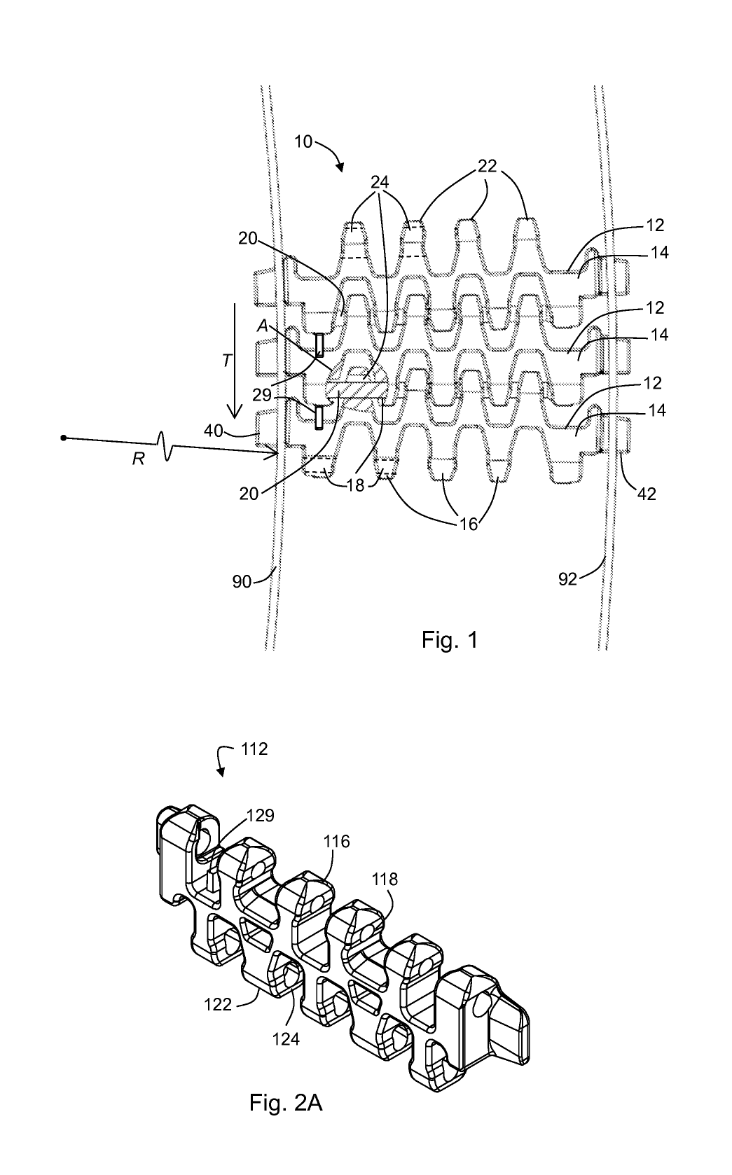

FIG. 1 depicts where the present invention is embodied as a conveyor belt 10 (only a portion of the conveyor belt 10 is shown). The conveyor belt 10 may be an endless modular belt as is commonly used in the art, able to travel around curves in a path of the conveyor—a radius conveyor belt. The conveyor belt 10 comprises a plurality of modules 12, each module 12 having an intermediate section 14. Each module 12 has a top surface 30 and a bottom surface 32 defining a thickness tₘ of the module 12. Each module 12 has a first side 34 and a second side 36 defining a width wₘ of the module 12.

A plurality of first link ends 16 extends outwardly from each intermediate section 14 in a direction of belt travel T. In this way, the first link ends 16 have a proximal end (the end nearest the intermediate section 14) and a distal end (the end furthest from the intermediate section 14). Each of the first link ends 16 has a transverse opening 18 for receiving a pivot rod 20 as further described below. In FIG. 1, only some of the transverse openings 18 are shown (as hidden lines), and one transverse opening 18 can be partially viewed in the cut-away portion A of the figure.

Each module 12 of the conveyor belt 10 further comprises a plurality of second link ends 22 outwardly extending from the intermediate section 14 in a direction opposite the first link ends 16—generally parallel with, but opposite to the direction of belt travel T. It will be recognized that the direction of the first link ends 16 and second link ends 22 may be switched such that it does not matter which link ends are the “leading” link ends and which are the “trailing” link ends (relative to movement of the belt). As with the first link ends 16, each of the second link ends has a proximal end and a distal end, with respect to the intermediate section 14. The second link ends 22 of each module 12 are configured to interdigitate with the first link ends 16 of the each corresponding adjacent module 12. In this way, the first link ends 16 and second link ends 22 may be described as offset with respect to each other. Each of the second link ends 22 has a transverse elongate opening 24 for receiving the pivot rod 20.

The conveyor belt 10 further comprises a plurality of pivot rods 20 for connecting adjacent modules 12. Each pivot rod 20 is disposed in the openings 18 of the first link ends 16 of a module 12 and the elongate openings 24 of the second link ends of a corresponding adjacent module 12. The openings 18 and elongate openings 24 are in registry when the first link ends 16 and second link ends 18 of adjacent modules 12 are interdigitated.

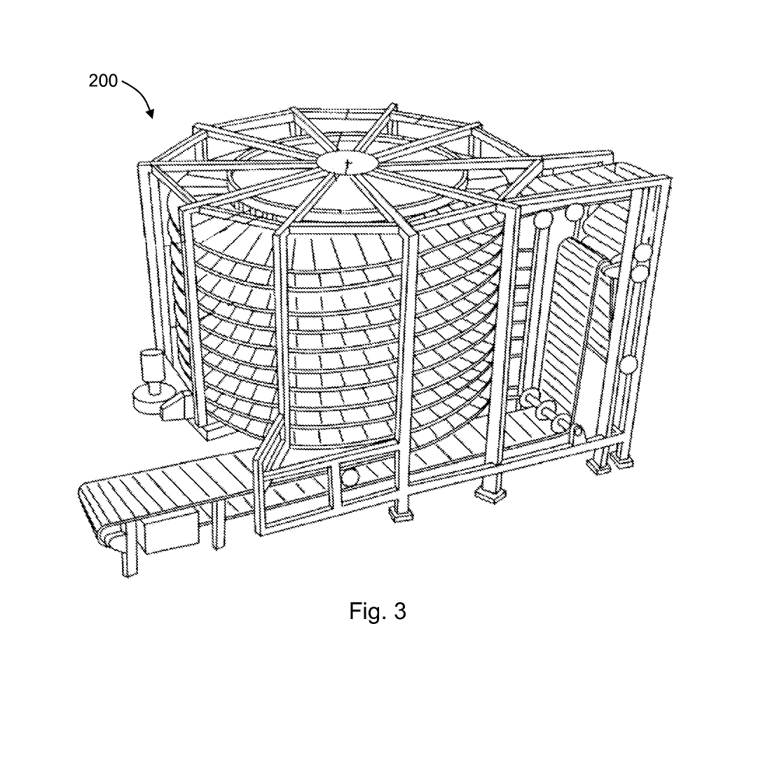

Each elongate opening 24 has a length Iₑₒ, which is the distance from a proximal extent 26 of the elongate opening 24 to a distal extent 28 of the elongate opening 24. The length Iₑₒ is greater than a diameter dₚᵣ of the pivot rods 20, and, as such, the modules 12 of a conveyor belt 10 may collapse with respect to each other (i.e., modules 12 move towards adjacent modules 12, decreasing the distance between modules 12). This ability to collapse allows the conveyor belt 10 to move along curved belt paths, such as, for example, the helical shape of a spiral conveyor system 100 (such as that depicted in FIG. 3).

The conveyor belt 10 of the present invention is a dampened movement conveyor belt. Each module 12 further comprises a dampener 29 attached to the module 12 and configured to reduce a magnitude of vibration transmitted between each module 12 and its adjacent module 12. The dampeners 29 are preferably made from a soft material, such as a material having a durometer rating indicating the material is soft. Such soft dampeners 29 are configured to cushion the modules 12 relative to the adjacent module(s) 12 thereby reducing the magnitude of noise and vibration transmitted between the modules 12. The dampeners 29 may be made from an elastomer. Each dampener 29 may be inserted into a respective elongate opening 24 to cushion the movement of the pivot rod 20 disposed in the elongate opening 24.

In another embodiment of a belt 10 of the present invention, the dampener 29 may be disposed on a link end 16, 22 of a module 12 and configured to contact and cushion the adjacent module 12 when the modules 12 collapse on a curve. In another embodiment of a belt 10, the dampener 29 may be disposed on the intermediate portion 14 of the module 12 and configured to contact and cushion a portion of the adjacent module 12.

The module 12 may further comprise a first guide 40 extending outwardly from the module 12 in a direction transverse to the direction of belt travel T. The module 12 may further comprise a second guide 42 extending outwardly from the module 12 in a direction opposite the direction of the first guide 40. The first and second guides 40, 42 are configured to interface with guide rails 90, 92 of a conveyor system configured with such rails 90, 92. In this way, the modules 12 of the conveyor belt 10 may be supported by the rails 90, 92 and/or guided by the rails 90, 92 along the belt path.

In some embodiments of a conveyor belt 10, the elongate openings 24 may be tapered. One or more of the elongate openings 24 may be configured such that a width wₚ at the proximal extent 26 is different than a width w_{d} at the distal extent 28. In this way, movement of the pivot rods 20 may be dampened by way of interference between the pivot rods 20 and the reduced-width elongate openings 24. Where the tapered elongate openings 24 are disposed at the inside of a curve in the belt 10, the taper may be configured such that the proximal extent 26 width wₚ is less than the distal extent 28 width w_{d}. In other embodiments, the taper may be configured such that the proximal extent 26 width wₚ is greater than the distal extent 28 width w_{d}. In other embodiments, the elongate openings 24 may have varying tapers depending on the link end position on a module 12 (from inside to outside of a curve).

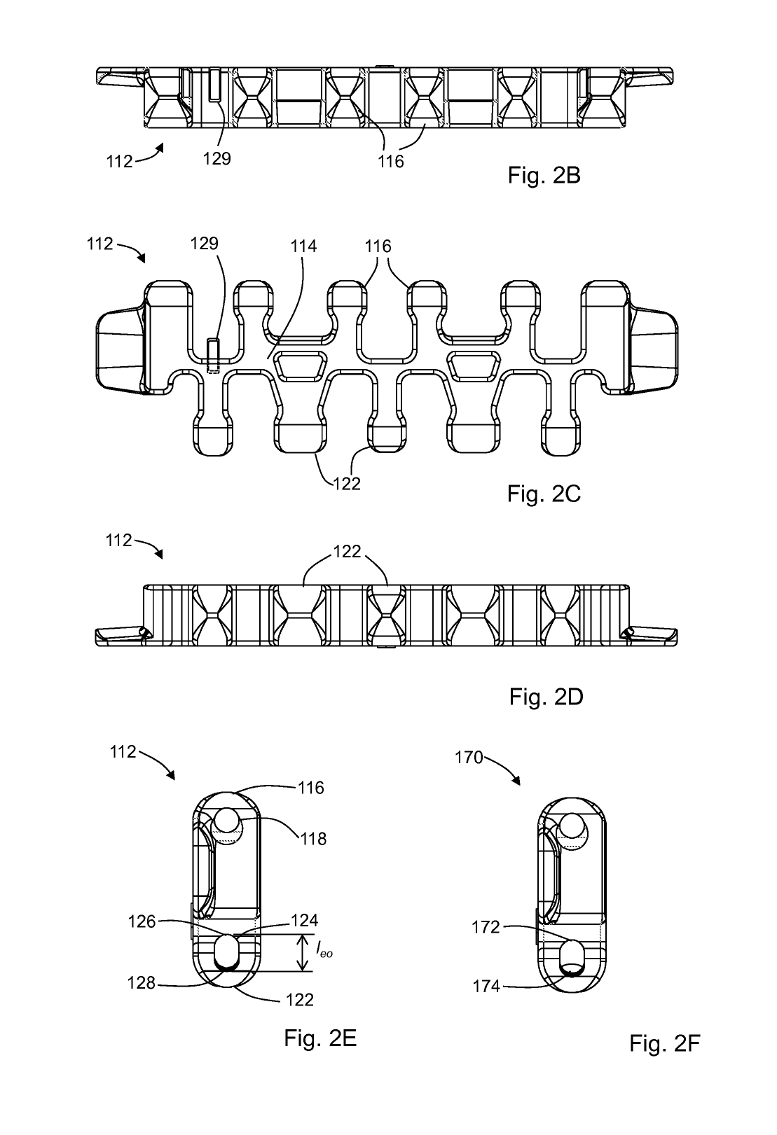

The present invention may be embodied as a module 112 for use in a dampened conveyor belt such as that previously described. See, e.g., FIGS. 2A-2E. The module 112 comprises an intermediate section 114 from which a plurality of first link ends 116 extend in a direction generally parallel to a direction of belt travel T. The first link ends 116 each have a transverse opening 118 defined therein. A plurality of second link ends 122 extends from the intermediate section 114 in a direction generally opposite the direction of the first link ends 116. The plurality of second link ends 122 is offset from the plurality of first link ends 116 such that the module 112 may be interdigitated with other modules to form a conveyor belt. Each second link end 122 has a transverse elongate opening 124. The elongate openings 124 are configured to be in registry with the openings of an adjacent module when the link ends of the module and the adjacent module are interdigitated. When in registry, a pivot rod may be received in the openings 118 and elongate openings 124 to connect the module 112 with the adjacent module.

The module 112 further comprises a dampener 129 attached to the module 112 and configured to reduce a magnitude of vibration transmitted between the module 112 and its adjacent modules when configured into a belt. The dampener 129 is preferably made from a soft material—i.e., having a durometer rating indicating the material is soft. Such soft dampeners 129 are configured to cushion the modules 112 relative to the adjacent module(s) 112 thereby reducing the magnitude of noise and vibration caused by chatter. The dampeners 129 may be made from an elastomer.

FIG. 2F depicts an embodiment wherein the dampener 174 is inserted into a respective elongate opening 172 of the module 170 to cushion the movement of the pivot rod when disposed in the elongate opening 172. In another embodiment of a belt module of the present invention, the dampener may be disposed on a link end of the module and configured to contact and cushion an adjacent module when the modules are configured into a radius belt. In another embodiment of a module 112, the dampener 129 may be disposed on the intermediate portion 114 of the module 112 and configured to contact and cushion a portion of an adjacent module 112.

Although the present invention has been described with respect to one or more particular embodiments, it will be understood that other embodiments of the present invention may be made without departing from the spirit and scope of the present invention.

There are numerous embodiments of the invention described herein including examples, all of which are intended to be non-limiting examples (whether explicitly described as non-limiting or not). Hence, the present invention is deemed limited only by the appended claims and the reasonable interpretation thereof.

What is claimed is:

1. A radius modular conveyor belt for traversing curved belt paths, comprising:
a plurality of modules, each module comprising:
an intermediate section;
a plurality of first link ends extending from the intermediate section parallel to a direction of belt travel and each first link end having a transverse opening defined therein;
a plurality of second link ends extending from the intermediate section in a direction opposite the first link ends and configured to interdigitate with the first link ends of an adjacent module, each second link end having a transverse elongate opening configured to allow collapsing together of the modules at an inside of a curve of the curved belt path;
a plurality of pivot rods, each pivot rod disposed in the openings and elongate openings of the interdigitated first and second link ends of adjacent modules; and
a plurality of dampeners, wherein each damper is attached to a module and configured to reduce a magnitude of vibration transmitted between the module and an adjacent module.

2. The conveyor belt of claim 1, wherein each module of the plurality of modules comprises more than one dampener.

3. The conveyor belt of claim 1, wherein each dampener is configured to reduce the magnitude of vibration transmitted between the module and an adjacent modules when at least one of the module or the adjacent module is within a curve of the curved belt path.

4. The conveyor belt of claim 1, wherein each dampener is disposed within an elongate opening of each module.

5. The conveyor belt of claim 1, wherein each dampener is affixed to a respective module and located such that the dampener will contact a first link end or second link end of an adjacent module when the modules are partially collapsed.

6. The conveyor belt of claim 1, wherein each elongate opening has a proximal end and a distal end, and wherein one or more of the elongate openings is configured such that a width of the elongate opening at the proximal end is different from a width of the elongate opening at the distal end, forming a taper for reducing vibration of the belt.

7. The conveyor belt of claim 6, wherein the width at the proximal end is less than the width at the distal end.

8. The conveyor belt of claim 6, wherein the width at the proximal end is greater than the width at the distal end.

9. The conveyor belt of claim 1, wherein the dampener is made from a material with a soft durometer rating.

10. A module for a radius conveyor belt, comprising:
an intermediate section;
a plurality of first link ends extending from the intermediate section parallel to a direction of belt travel and having a transverse opening defined therein;
a plurality of second link ends extending from the intermediate section in a direction opposite the first link ends and configured to interdigitate with first link ends of an adjacent module, the second link ends having a transverse elongate opening configured to receive a pivot rod to connect the second link ends to the first link ends of the adjacent module; and
a damper portion configured to reduce a magnitude of vibration transmitted between the module and an adjacent module when configured as a belt.
